(19) United States
(12) Patent Application Publication
(10) Pub. No.: US 2025/0058248 A1
(43) Pub. Date: Feb. 20, 2025

(54) LIQUID-LIQUID EXTRACTION COLUMN WITH VARIABLE INTER-TRAY SPACE

(71) Applicant: IFP ENERGIES NOUVELLES, Rueil-Malmaison (FR)

(72) Inventors: Hélène LORCET, Rueil-Malmaison Cedex (FR); Frederic AUGIER, Rueil-Malmaison Cedex (FR); Jeremy GAZARIAN, Rueil-Malmaison Cedex (FR); Pierre-Olivier DREGER, Rueil-Malmaison Cedex (FR)

(73) Assignee: IFP ENERGIES NOUVELLES, Rueil-Malmaison (FR)

(21) Appl. No.: 18/721,419

(22) PCT Filed: Dec. 12, 2022
(86) PCT No.: PCT/EP2022/085390

§ 371 Date: Jun. 18, 2024

(30) Foreign Application Priority Data
Dec. 20, 2021 (FR) FR2114004

(51) Int. Cl. B01D 11/04; B01D 11/00; B01J 19/32

(52) U.S. Cl. CPC B01D 11/043; B01D 11/0492; B01J 19/32; B01D 2011/002; B01J 2219/32213; B01J 2219/32262; B01J 2219/3325

(57) ABSTRACT

Liquid-liquid extraction column (1) comprising injection points for feedstock (2), for washing (3) and for backwashing (4), two withdrawal points (5, 6), trays (Pᵢ) located along the column and defining 2 to 30 zones each comprising at least two trays, the n zones comprising: at least one extraction zone Zᵢ comprising the zones from Z₁ to Zₓ, x being greater than or equal to 1, and at least one backwash zone comprising the zones from Zₓ₊₁ to Zₙ, n being greater than x; in which the trays of one and the same zone exhibit one and the same height H of inter-tray space (10); in which, when x>1, the height H of the zones Zᵢ increases when i increases; and, when x=1, the height H of the at least one backwash zone is less than the height H of zone Z₁.

### TECHNICAL FIELD

The field of the invention relates to a column (extractor) for the liquid-liquid separation of hydrocarbon compounds, such as aromatic (e.g. A6-A11) compounds originating from broad hydrocarbon cuts (e.g. C6-C11 cut, such as originating from a catalytic cracking unit (FCC, Fluid Catalytic Cracking).

### PRIOR ART

A liquid-liquid extraction operation is a key building block of processes performing the separation of hydrocarbon cuts, such as the separation of a mixture of aromatic and non-aromatic compounds. The operating principle is based on the differences in solubility of the compounds of a homogeneous liquid feedstock in an appropriate solvent (e.g. a polar aprotic solvent, such as sulfolane or DMSO). The addition to the feedstock of a partially miscible solvent causes the appearance of a second phase to which a portion of the compounds (e.g. the aromatic compounds), which are the most soluble constituents, is preferentially transferred.

Typically, the liquid-liquid extraction technology employs a liquid-liquid separation column comprising a plurality of perforated trays equipped with one or more weirs per tray, depending on the targeted capacities (reference is made to one-pass or two-pass tray or to multi-pass tray when there are more than three weirs).

The design rules for a conventional liquid-liquid extraction column consider a reference tray sized according to the maximum flow rates of each phase and their physicochemical properties. This design is subsequently employed for the whole of the column by the stacking of a plurality of trays, the trays thus all being substantially identical.

The Applicant Company has identified, on the other hand, that the operation of a liquid-liquid extraction column can give rise to substantial variability, depending in particular:
on the flow rate of each of the phases along the column-this phenomenon is linked, first, to the material transfer of solutes from the feedstock to the solvent and, secondly, to the possibility of modulating the backwash flow rate according to the nature of the feedstock and the targeted specifications; and
on the physicochemical properties and in particular on the interfacial tension between the feedstock and the solvent linked to the gradual enrichment in compounds extracted from the feedstock to the solvent.

The object of the present invention is to overcome the abovementioned deficiencies.

### SUMMARY OF THE INVENTION

In the context described above, a first object of the present description is to provide a liquid-liquid extraction column which makes possible:
the retention of a range of between 5% and 20% of the average volume fraction of dispersed phase (i.e., solvent/heavy phase) in a compartment (i.e., zone comprising a perforated tray and an adjacent inter-tray space);
the non-entrainment of the droplets of dispersed phase into the weirs by the continuous phase (i.e. feedstock/light phase), in order to limit the axial mixing of the dispersed phase;
a height of coalesced layer of the dispersed phase on each tray which is sufficient to prevent the passage of the continuous phase through the perforated tray (and to force the exclusive passage of the continuous phase into the weirs);
a suitable continuous phase transverse velocity, which does not perturb the flow of the dispersed phase.

Surprisingly, the Applicant Company has identified that specific characteristics of perforated trays, such as the height of the inter-tray spaces, make it possible to control the hydrodynamics along the entire column, while limiting the axial mixing. This technical solution makes it possible to retain a satisfactory material transfer efficiency on each tray.

According to a first aspect, the abovementioned objects, and also other advantages, are obtained by a liquid-liquid extraction column, comprising the following elements:
a first injection point for a first phase located at an intermediate position between the top and the bottom of the column;
a second injection point for a second phase and a third injection point for a backwash liquid, one (of the second and third injection points) being located at the top of the column and the other being located at the bottom of the column;
a first withdrawal point for an extract and a second withdrawal point for a raffinate, one (of the first and second withdrawal points) being located at the bottom of the column and the other being located at the top of the column;
a plurality of trays located in the column (for example from the top of the column to the bottom of the column or from the bottom of the column to the top of the column) and defining n zones, each zone comprising at least two trays, n being between 2 and 30, preferably between 3 and 30;

in which the n zones comprise:
at least one extraction zone Zᵢ included between a zone (e.g. column top zone) Z₁ comprising the second injection point for the second phase (and the second withdrawal point for the raffinate) and a feed zone Zₓ comprising the first injection point for the first phase, x being greater than or equal to 1 (preferably x is greater than 1); and
at least one backwash zone included between a zone Zₓ₊₁ and a zone (e.g. column bottom zone) Zₙ comprising the third injection point for the backwash liquid (and the first withdrawal point for the extract), n being greater than x;

in which the trays of one and the same zone exhibit substantially one and the same height H of inter-tray space; and in which:
when x is greater than 1, the height H of the inter-tray spaces of the zones Zᵢ increases when the value i increases; and
when x is equal to 1, the height H of the inter-tray spaces of the at least one backwash zone is less than the height H of the inter-tray spaces of the zone Z₁.

According to one or more embodiments, n is between 3 and 30, and x is greater than 1.

According to one or more embodiments, the liquid-liquid extraction column comprises the following elements:
a first injection point for a first phase located at an intermediate position between the top and the bottom of the column;
a second injection point for a second phase located at the top of the column;
a third injection point for a backwash liquid located at the bottom of the column;
a first withdrawal point for an extract located at the bottom of the column;
a second withdrawal point for a raffinate located at the top of the column;
a plurality of trays located in the column, for example from the top of the column to the bottom of the column or from the bottom of the column to the top of the column, and defining n zones, each zone comprising at least two trays, n being between 3 and 30;

in which the n zones comprise:
a plurality of extraction zones Zᵢ included between a column top zone Z₁ comprising the second injection point for the second phase (and the second withdrawal point for the raffinate) and a feed zone Zₓ comprising the first injection point for the first phase, x being greater than 1; and
at least one backwash zone included between a zone Zₓ₊₁ and a column bottom zone Zₙ comprising the third injection point for the backwash liquid (and the first withdrawal point for the extract), n being greater than x;

in which the trays of one and the same zone exhibit substantially one and the same height H of inter-tray space; and

in which the height H of the inter-tray spaces of the zones Zᵢ increases when the value i increases.

According to one or more embodiments, the liquid-liquid extraction column comprises the following elements:
a first injection point for a first phase located at an intermediate position between the top and the bottom of the column;
a second injection point for a second phase located at the bottom of the column;
a third injection point for a backwash liquid located at the top of the column;
a first withdrawal point for an extract located at the top of the column;

a second withdrawal point for a raffinate located at the bottom of the column;
a plurality of trays located in the column, for example from the top of the column to the bottom of the column or from the bottom of the column to the top of the column, and defining n zones, each zone comprising at least two trays, n being between 3 and 30;

in which the n zones comprise:
a plurality of extraction zones Zᵢ included between a column bottom zone Z₁ comprising the second injection point for the second phase (and the second withdrawal point for the raffinate) and a feed zone Zₓ comprising the first injection point for the first phase, x being greater than 1; and
at least one backwash zone included between a zone Zₓ₊₁ and a column top zone Zₙ comprising the third injection point for the backwash liquid (and the first withdrawal point for the extract), n being greater than x;

in which the trays of one and the same zone exhibit substantially one and the same height H of inter-tray space; and

in which the height H of the inter-tray spaces of the zones Zᵢ increases when the value i increases.

According to one or more embodiments, in the extraction zones Zᵢ where i varies from 1 to x (i.e., x greater than 1), the ratio of the height H of an inter-tray space of a zone Zᵢ to the height H of an inter-tray space of a zone Zᵢ₊₁ is between 0.20 and 0.95.

According to one or more embodiments, in the extraction zones Zᵢ where i varies from 1 to x (i.e., x greater than 1), the ratio of the height H of an inter-tray space of a zone Zᵢ to the height H of an inter-tray space of a zone Zᵢ₊₁ is between 0.40 and 0.90.

According to one or more embodiments, in the extraction zones Zᵢ where i varies from 1 to x (i.e., x greater than 1), the ratio of the height H of an inter-tray space of a zone Zᵢ to the height H of an inter-tray space of a zone Zᵢ₊₁ is between 0.75 and 0.85.

According to one or more embodiments, when x is equal to 1, the ratio of the height H of an inter-tray space of the at least one backwash zone to the height H of the inter-tray space of the zone Z₁ is between 0.20 and 0.95.

According to one or more embodiments, the at least one backwash zone is a plurality of zones, from a zone Zₓ₊₁ to the (e.g. column bottom) zone Zₙ, and in which the height H of the inter-tray spaces increases, is constant, or decreases from the zone Zₓ₊₁ to the zone Zₙ.

According to one or more embodiments, the at least one backwash zone is a plurality of zones subdivided into:
a plurality of zones Zⱼ included between the zone Zₓ₊₁ and a zone Z_{y}, y being greater than x+1; and
a plurality of zones Zₖ included between the zone Z_{y+1} and the (e.g. column bottom) zone Zₙ, and

in which:
in the zones Zⱼ where j varies from x+1 to y, the height H of the inter-tray spaces increases, is constant, or decreases when the value j increases; and/or
in the zones Zₖ where k varies from y+1 to n, the height H of the inter-tray spaces increases, is constant, or decreases when the value k increases.

According to one or more embodiments, in the zones Zⱼ where j varies from x+1 to y, the ratio of the height H of the inter-tray spaces of a zone Zⱼ to the height H of the inter-tray spaces of a zone Zⱼ₊₁ is between 0.20 and 0.95.

According to one or more embodiments, in the zones Zⱼ where j varies from x+1 to y, the ratio of the height H of the inter-tray spaces of a zone Zⱼ to the height H of the inter-tray spaces of a zone Zⱼ₊₁ is between 1.10 and 2.0.

According to one or more embodiments, in the zones Zₖ where k varies from y+1 to n, the ratio of the height H of the inter-tray spaces of a zone Zₖ to the height H of the inter-tray spaces of a zone Zₖ₊₁ is between 0.20 and 0.95.

According to one or more embodiments, in the zones Zₖ where k varies from y+1 to n, the ratio of the height H of the inter-tray spaces of a zone Zₖ to the height H of the inter-tray spaces of a zone Zₖ₊₁ is between 1.10 and 2.0.

According to one or more embodiments, the number of zones Zᵢ is between 2 and 10 and/or the number of backwash zones is between 1 and 10.

According to one or more embodiments, the number of zones Zⱼ is between 2 and 10 and/or the number of zones Zₖ is between 2 and 10.

According to one or more embodiments, the height H of the inter-tray spaces of the backwash zone Zₓ₊₁ is less than, equal to or greater than the height H of the inter-tray spaces of the extraction zone Zₓ.

According to one or more embodiments, the height H of the inter-tray spaces of the backwash zone Zₓ₊₁ is less than the height H of the inter-tray spaces of the extraction zone Zₓ.

According to one or more embodiments, the height H of each inter-tray space is between 0.2 m and 1.2 m.

Embodiments of the liquid-liquid extraction column according to the first aspect and also other characteristics and advantages will become apparent on reading the description which will follow, which is given purely by way of non-limiting illustration, and with reference to the following drawings.

### LIST OF THE FIGURES

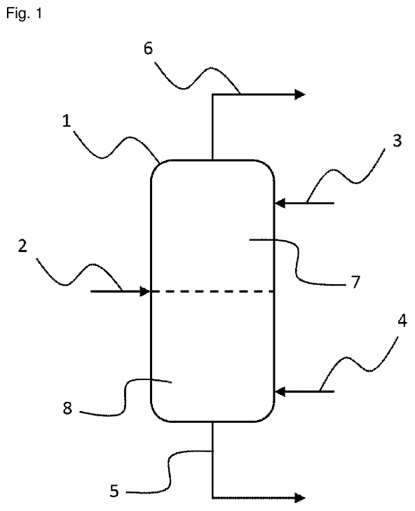

The FIG. 1 diagrammatically shows a cross-sectional view of a liquid-liquid extraction column according to the present invention.

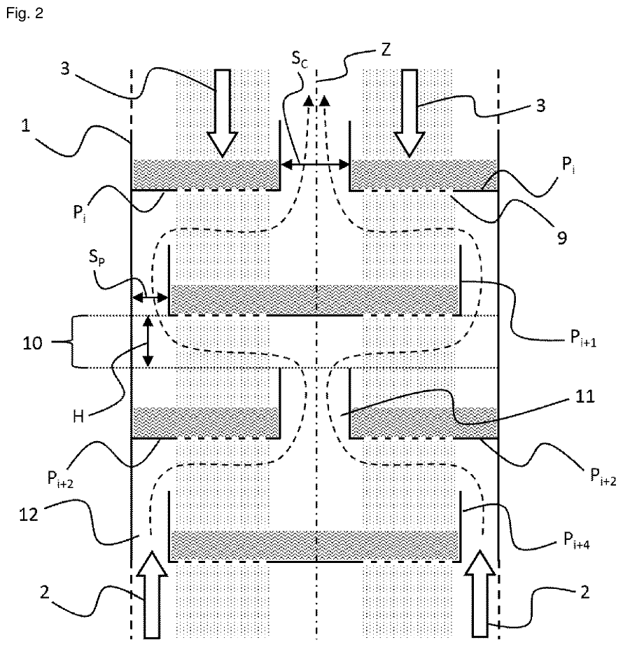

The FIG. 2 diagrammatically shows a cross-sectional view of the flow of the dispersed phase and of the continuous phase in a liquid-liquid extraction column according to the present invention.

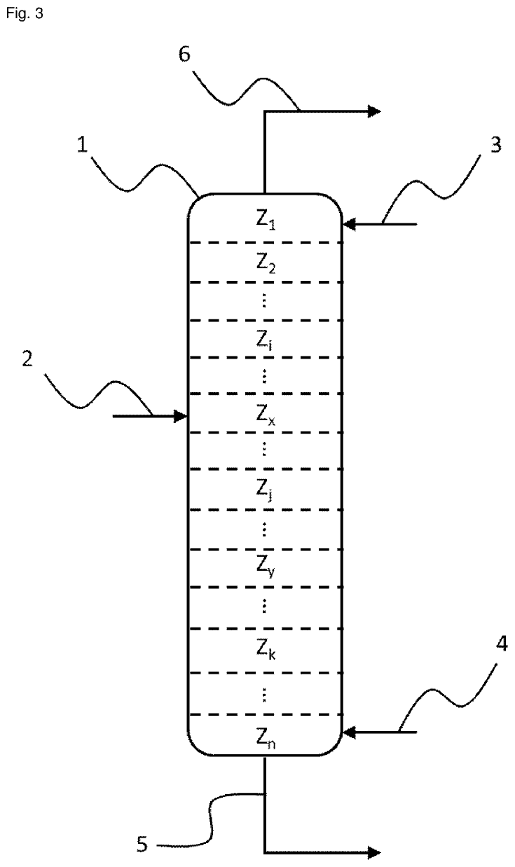

The FIG. 3 diagrammatically shows a cross-sectional view of a liquid-liquid extraction column according to the present invention defined by a plurality of zones Zᵢ included between the column top zone 1 and the feed zone Zₓ, a plurality of zones Zⱼ included between the zone Zₓ₊₁ and a zone Z_{y}, and a plurality of zones Zₖ included between the zone Z_{y+1} and the column bottom zone Zₙ.

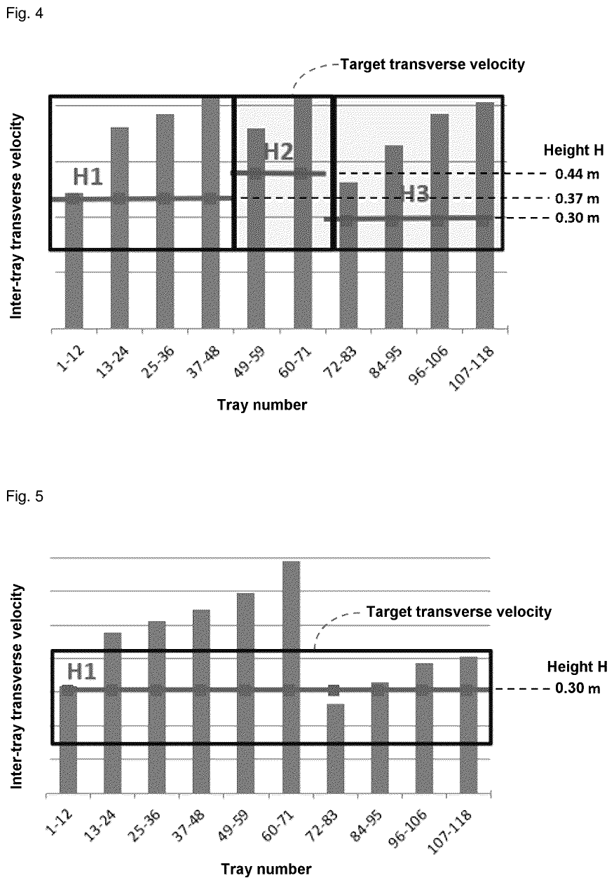

The FIG. 4 is a graph showing the change in the inter-tray transverse velocity of the continuous phase along a liquid-liquid extraction column according to the present invention, in which the height H of the inter-tray spaces is variable.

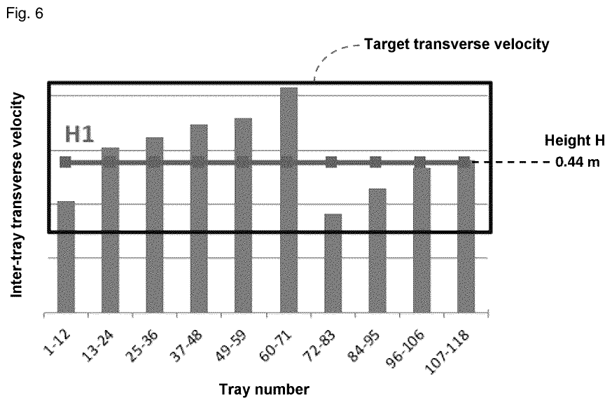

The FIG. 5 and the FIG. 6 are graphs showing the change in the inter-tray transverse velocity of the continuous phase along reference liquid-liquid extraction columns, in which the height H of the inter-tray spaces is constant.

### DESCRIPTION OF THE EMBODIMENTS

Embodiments of the invention will now be described in detail. In the following detailed description, many specific details are presented in order to provide a deeper understanding of the invention. However, it will be apparent to a person skilled in the art that the invention can be implemented without these specific details. In other cases, well-known characteristics have not been described in detail in order to avoid unnecessarily complicating the description.

In the present description, the term “to comprise” is synonymous with (means the same thing as) “to include” and “to contain”, and is inclusive or open-ended and does not exclude other unrecited elements. It is understood that the term “to comprise” includes the exclusive and closed term “to consist”. In addition, in the present description, the term “substantially” corresponds to an approximation of ±10%, preferably of ±5%, very preferably of ±2%, of a reference value, such as a distance, a velocity, a flow rate, a content of compounds, a temperature, a pressure, and the like.

With reference to FIG. 1, a liquid-liquid extraction column 1 comprises the following elements:
a first injection point for a first phase 2 (or liquid to be separated), such as a feedstock (e.g. a mixture of aromatic and non-aromatic C6-C11 compounds), located at an intermediate position between the top and the bottom of the column 1;
a second injection point for a second phase 3 (or separation liquid), such as a solvent (e.g. sulfolane), located at the top of column 1;
a third injection point for a backwash liquid 4, such as a recycle (e.g. a mixture comprising at least 50% by weight of light compounds (i.e., C5-C8, preferably C5-C6, compounds)), located at the bottom of column 1;
a first withdrawal point for an extract 5 (in liquid phase), such as a solvent enriched in extracted compounds (e.g. aromatic compounds), located at the bottom of column 1; and
a second withdrawal point for a raffinate 6 (in liquid phase), such as a feedstock depleted in extracted compounds, located at the top of column 1.

In addition, in order to increase the yield and the purity, two distinct operating zones are defined opposite the injection point for the liquid to be separated 2:
an extraction sector 7, extending substantially from the first injection point for the first phase 2 up to substantially the second injection point for the second phase 3, makes it possible in particular to extract compounds (e.g. aromatics) from the liquid to be separated 2 by counter-currentwise contacting with the separation liquid 3 (the “yield” zone), and
a backwash sector 8, adjacent to the extraction sector 7 and extending up to substantially the third injection point for the backwash liquid 4, makes it possible in particular to backwash undesired compounds (e.g. heavy non-aromatic compounds) contained in the extract 5 by the backwash liquid 4 in order to guarantee a high level of purity.

Specifically with reference to FIG. 1, the separation liquid exits from the column 1 while entraining advantageous compounds to be separated (e.g. aromatic compounds) to form the extract 5. The extract may also contain undesired compounds (e.g. light non-aromatic compounds, such as C6-C7 compounds) which can be separated downstream (e.g. by distillation and/or stripping). Advantageously, the extract 5 contains no (or very few) undesired compounds which are difficult to separate (e.g. heavier non-aromatic compounds, such as C8+ compounds), which are separated from the extract in the backwash sector 8. With reference to FIG. 1, the separation liquid 3 is heavier than the liquid to be separated 2 and is injected at the top of column 1, while the backwash liquid 4 is injected at the bottom of column 1. It is understood that the present invention also relates to liquid-liquid extraction columns, in which the separation liquid is lighter than the liquid to be separated 2, the injection point for the separation liquid 3 is at the bottom of column 1 and the injection point for the backwash liquid 4 is at the top of column 1.

With reference to FIG. 2, a two-pass liquid-liquid extraction column 1 comprises n perforated trays Pᵢ, i being between 1 and n. Each perforated tray Pᵢ is located so that the dispersed phase (i.e., the separation liquid 3 heavier than the liquid to be separated 2) flows through the holes 9 of the perforated tray Pᵢ, the droplets of the dispersed phase recoalescing on the following perforated tray Pin to form a liquid volume preventing the passage of the continuous phase (i.e., the liquid to be separated 2 lighter than the separation liquid 3) through the perforated tray Pᵢ₊₁. The liquid to be separated 2 flows counter-currentwise relative to the separation liquid 3, i.e. upwards through the central weirs 11 and the peripheral weirs 12 of cross-section S_{C} and S_{P}, respectively, and transversely in an inter-tray space 10 of height H. With reference to FIG. 2, the heavy phase is the dispersed phase and the light phase is the continuous phase. It is understood that a liquid-liquid extraction column 1 can comprise perforated trays which are adapted in order for the dispersed phase to be the light phase and the continuous phase to be the heavy phase.

According to one or more embodiments, the perforated trays Pᵢ are one-pass (e.g. one type of weir) or two-pass (e.g. two types of weirs) or multi-pass trays.

The Applicant Company has identified that the operation of a liquid-liquid extraction column can give rise to significant variations in flow rate and in the physicochemical properties of the phases moving in the column, and that the use of trays which differ according to their position in the column can result in homogeneous efficiency of the column being guaranteed, unlike the prior art.

According to the invention, with reference to FIG. 3, a liquid-liquid extraction column 1 is also defined by:
at least one extraction zone Zᵢ and preferably a plurality of extraction zones Zᵢ defining the extraction sector 7, i.e. the extraction zone(s) Zᵢ are included between the column top zone Z₁ comprising the second injection point for the second phase 3, and the feed zone Zₓ comprising the first injection point for the first phase 2, x being greater than or equal to 1, preferably x being greater than 1; and
at least one backwash zone defining the backwash sector 8, i.e. the backwash zone(s) is/are included between the zone Zₓ₊₁ and the column bottom zone Zn comprising the third injection point for the backwash liquid 4, n being greater than x.

According to the invention, each extraction and backwash zone comprises at least two trays, each extraction and backwash zone defining the structural characteristics of the inter-tray spaces present in said extraction and backwash zones. Thus, according to the invention, the trays Pᵢ of one and the same extraction or backwash zone exhibit substantially the same inter-tray space 10 height H.

According to one or more embodiments, with reference to FIG. 3, the at least one backwash zone is a plurality of zones, said plurality of zones starting from the zone Zₓ₊₁ to the column bottom zone Zₙ.

According to one or more embodiments, with reference to FIG. 3, the at least one backwash zone is a plurality of zones subdivided into:
a plurality of zones Zⱼ included between the zone Zₓ₊₁ and a zone Z_{y}, y being greater than x+1; and
a plurality of zones Zₖ included between the zone Z_{y+1} and the column bottom zone Zₙ.

Advantageously, the number of zones Zᵢ, Zⱼ and Zₖ can be defined relative to the flow rate variability and the physicochemical properties of the phase passing through said zones Zᵢ, Zⱼ and Zₖ.

According to one or more embodiments, the total number n of zones is between 2 and 30, preferably between 3 and 30, very preferably between 4 and 24, such as between 4 and 18, in particular between 4 and 8.

In the present description, i, j, k, x, y and n are natural integers.

The number of extraction zones Zᵢ can be defined relative to the phase which exhibits the most flow rate variability in the column. According to one or more embodiments, the number of zones Zᵢ (number of zones Z₁ to Zₓ) is between 1 and 10, preferably between 2 and 10, very preferably between 2 and 6, such as between 2 and 4.

The number of backwash zones can be defined relative to the phase which exhibits the most flow rate variability in the column. According to one or more embodiments, the number of backwash zones (number of zones Zₓ₊₁ to Zₙ) is between 1 and 10, preferably between 1 and 6, very preferably between 1 and 4. According to one or more embodiments, the number of backwash zones (number of zones Zₓ₊₁ to Zₙ) is greater than or equal to 2.

The number of zones Zⱼ can be defined relative to the phase which exhibits the most flow rate variability in the column. According to one or more embodiments, the number of zones Zⱼ (number of zones Zₓ₊₁ to Z_{y}) is between 2 and 10, preferably between 2 and 6, very preferably between 2 and 4.

The number of zones Zₖ can be defined relative to the phase which exhibits the most flow rate variability in the column. According to one or more embodiments, the number of zones Zₖ (number of zones Z_{y+1} to Zₙ) is between 2 and 10, preferably between 2 and 6, very preferably between 2 and 4.

According to one or more embodiments, the number of trays per zone Zᵢ, Zⱼ and Zₖ can be determined by the number of actual stages required for the separation divided by the number of zones Zᵢ, Zⱼ and Zₖ.

### Control of the Flow Rate Variation of the Continuous Phase by Optimized Design of the Inter-Tray Space

Advantageously, the liquid-liquid extraction column 1 according to the invention comprises inter-tray spaces 10 having variable height H so that the transverse velocity (orthogonal to the central axis Z of the column) of the continuous phase remains substantially constant in the column. This is because, due to the fluctuation in the flow rate of the continuous phase during the passage through the column, the variation in the height H of the inter-tray spaces 10 makes possible a more homogeneous distribution of the continuous phase in the inter-tray space 10, preventing in particular recirculations and dead volumes, while limiting the distortion of the flow of the dispersed phase. This solution additionally makes it possible to reduce the axial mixing of the continuous phase and of the dispersed phase.

Specifically, in order to retain a substantially constant transverse velocity of the continuous phase, the liquid-liquid extraction column 1 according to the invention is divided into:
x extraction zones Zᵢ, and
n-x backwash zones.

According to one or more embodiments, the backwash zones are divided into:
Y zones Zⱼ located starting from the zone Zₓ₊₁ adjacent to the feed zone Zₓ up to a zone Z_{y}, for example where the height ratio between two consecutive zones Hⱼ/Hⱼ₊₁ remains less than 1, and
N zones Zₖ, including the zones Z_{y+1} to Zₙ.

According to the invention, when x is equal to 1, the height H of the inter-tray spaces 10 of the at least one backwash zone (e.g. the zone Z₂) is less than the height H of the inter-tray spaces 10 of the zone Z₁. According to one or more embodiments, when x is equal to 1, the ratio of the height H of an inter-tray space 10 of the at least one backwash zone (e.g. the zone Z₂) to the height H of the inter-tray space 10 of the zone Z₁ is between 0.20 and 0.95, preferably between 0.40 and 0.90, very preferably between 0.75 and 0.85.

According to the invention, when x is greater than 1, in the extraction zones Zᵢ where i varies from 1 to x (in the extraction sector 7), the height H of the inter-tray spaces 10 increases when the value i increases. According to one or more embodiments, in the zones Zᵢ where i varies from 1 to x, the ratio of the height H of an inter-tray space 10 of a zone Zᵢ to the height H of an inter-tray space 10 of a zone Zᵢ₊₁ is between 0.20 and 0.95, preferably between 0.40 and 0.90, very preferably between 0.75 and 0.85.

According to one or more embodiments, the at least one backwash zone comprises a plurality of zones, i.e. from the zone Zₓ₊₁ to the column bottom zone Zₙ, and the height H of an inter-tray space 10 increases from the zone Zₓ₊₁ to the column bottom zone Zₙ.

According to one or more embodiments, the at least one backwash zone comprises a plurality of zones, i.e. from the zone Zₓ₊₁ to the column bottom zone Zₙ, and the height H of an inter-tray space 10 is constant from the zone Zₓ₊₁ to the column bottom zone Zₙ.

According to one or more embodiments, the at least one backwash zone comprises a plurality of zones, i.e. from the zone Zₓ₊₁ to the column bottom zone Zₙ, and the height H of an inter-tray space 10 decreases from the zone Zₓ₊₁ to the column bottom zone Zₙ.

According to one or more embodiments, in the zones Zⱼ where j varies from x+1 to y (in the backwash zone 8), the height H of the inter-tray spaces 10 increases when the value j increases. According to one or more embodiments, in the zones Zⱼ where j varies from x+1 to y, the ratio of the height H of an inter-tray space 10 of a zone Zⱼ to the height H of an inter-tray space 10 of a zone Zⱼ₊₁ is between 0.20 and 0.95, preferably between 0.40 and 0.90, very preferably between 0.75 and 0.85.

According to one or more embodiments, in the zones Zⱼ where j varies from x+1 to y (in the backwash zone 8), the height H of the inter-tray spaces 10 is constant.

According to one or more embodiments, in the zones Zⱼ where j varies from x+1 to y (in the backwash zone 8), the height H of the inter-tray spaces 10 decreases when the value j increases. According to one or more embodiments, in the zones Zⱼ where j varies from x+1 to y, the ratio of the height H of an inter-tray space 10 of a zone Zⱼ to the height H of an inter-tray space 10 of a zone Zⱼ₊₁ is between 1.10 and 2.0, preferably between 1.20 and 1.60, very preferably between 1.25 and 1.50.

According to one or more embodiments, in the zones Zₖ where k varies from y+1 to n (in the backwash sector 8), the height H of the inter-tray spaces 10 increases when the value k increases. According to one or more embodiments, in the zones Zₖ where k varies from y+1 to n, the ratio of the height H of an inter-tray space 10 of a zone Zₖ to the height H of an inter-tray space 10 of a zone Zₖ₊₁ is between 0.20 and 0.95, preferably between 0.40 and 0.90, very preferably between 0.75 and 0.85.

According to one or more embodiments, in the zones Zₖ where k varies from y+1 to n (in the backwash zone 8), the height H of the inter-tray spaces 10 is constant.

According to one or more embodiments, in the zones Zₖ where k varies from y+1 to n (in the backwash sector 8), the height H of the inter-tray spaces 10 decreases when the value k increases. According to one or more embodiments, in the zones Zₖ where k varies from y+1 to n, the ratio of the height H of an inter-tray space 10 of a zone Zₖ to the height H of an inter-tray space 10 of a zone Zₖ₊₁ is between 1.10 and 2.0, preferably between 1.20 and 1.60, very preferably between 1.25 and 1.50.

According to one or more embodiments, in the zones Zⱼ where j varies from x+1 to y, the height H of the inter-tray spaces 10 decreases when the value j increases; and, in the zones Zₖ where k varies from y+1 to n, the height H of the inter-tray spaces 10 increases when the value k increases.

According to one or more embodiments, in the zones Zⱼ where j varies from x+1 to y, the height H of the inter-tray spaces 10 increases when the value j increases; and, in the zones Zₖ where k varies from y+1 to n, the height H of the inter-tray spaces 10 decreases when the value k increases.

According to one or more embodiments, the height H of the inter-tray spaces 10 of the backwash zone Zₓ₊₁ is greater than, equal to or less than the height H of the inter-tray spaces 10 of the extraction zone Zₓ. According to one or more embodiments, the height H of the inter-tray spaces 10 of the backwash zone Zₓ₊₁ is less than the height H of the inter-tray spaces 10 of the extraction zone Zₓ. According to one or more embodiments, the ratio of the height H of the inter-tray space 10 of the zone Zₓ₊₁ to the height H of the inter-tray space 10 of the zone Zₓ is between 0.20 and 0.95, preferably between 0.40 and 0.90, very preferably between 0.75 and 0.85.

According to one or more embodiments, the height H of each inter-tray space 10 is between 0.2 m and 1.2 m, preferably between 0.3 m and 0.7 m, very preferably between 0.3 m and 0.5 m.

### EXAMPLES

### Example 1

### Liquid-Liquid Extraction Column Having a Variable Inter-Tray Space

This example is targeted at describing the effect on the adjustment of the inter-tray space on the uniformity in the velocities of the continuous phase at this level.

The column exhibits a diameter of 4.9 m and comprises a succession of 118 perforated trays. The feedstock is injected at intermediate tray No. 71. The heavy solvent is injected at the top of the column at tray 1. The backwash solvent is injected at the bottom of the column at tray 118.

Three zones are defined for adjusting the inter-tray space to the variations in flow rate of the continuous phase along the column:
the first zone Z₁ is between trays 1 to 48: the inter-tray space is of height H1 of 0.37 m, the remainder of the geometry being unchanged;
the second zone Z₂ is between trays 49 to 71: the inter-tray space is increased to a height H2 of 0.44 m, relative to the increase in flow rate of the continuous phase, the zones Z₁ and Z₂ corresponding to the extraction sector 7; and
the third zone Z₃ is between trays 72 to 118: this zone corresponds to the backwash sector 8, the inter-tray space being of height H3 of 0.30 m.

In the extraction section 7 included between the top tray x=1 and the feed tray x=71, the height H of the inter-tray space 10 of the zone Z₁ is less than the height H of an inter-tray space 10 of the zone Z₂: the ratio of the height H of the inter-tray space 10 of the zone Z₁ to the height H of the inter-tray space 10 of the zone Z₂ is equal to 0.84.

FIG. 4 illustrates the technical effect of this adjustment: it makes it possible to guarantee uniformity of hydraulic operation along the column: the velocity of the inter-tray continuous phase is at every point in an optimum range. Such a solution makes it possible to guarantee unvarying performance qualities whatever the variations in flow rate of the continuous phase along the column, while guaranteeing an optimized column height.

### Example 2

### Liquid-Liquid Extraction Column Having a Constant Inter-Tray Space

The column exhibits a diameter of 4.9 m and a height of 42 m and is composed of a succession of 118 perforated trays. The feedstock is injected at intermediate tray No. 71. The heavy solvent is injected at the top of the column at tray 1. The backwash solvent is injected at the bottom of the column at tray 118.

No adjustment is employed: the inter-tray space is constant (H=0.3 m) and the characteristics of the trays are identical in every respect.

FIG. 5 illustrates that, without adjustment of the inter-tray space, the transverse velocity of the continuous phase can exceed the target maximum values and thus damage the effectiveness of trays 13 to 71, beyond which target maximum values the transverse velocity perturbs in particular the flow of the dispersed phase and entrains droplets of dispersed phase.

In order to remove the difficulty of transverse velocity exceeding the target maximum values, the height of the inter-tray space is increased (H of 0.44 m) at every point of the column: such a solution is illustrated in FIG. 6; it results in an increase in the column height of 25%.

1. Liquid-liquid extraction column (1) comprising the following elements:
a first injection point for a first phase (2) located at an intermediate position between the top and the bottom of the column (1);
a second injection point for a second phase (3) and a third injection point for a backwash liquid (4), one being located at the top of the column (1) and the other being located at the bottom of the column (1);
a first withdrawal point for an extract (5) and a second withdrawal point for a raffinate (6), one being located at the bottom of the column (1) and the other being located at the top of the column (1);
a plurality of trays (Pᵢ) located in the column (1) and defining n zones, each zone comprising at least two trays (Pᵢ), n being between 2 and 30;
in which the n zones comprise:
at least one extraction zone Zᵢ included between a zone Z₁ comprising the second injection point for the second phase (3), and a feed zone Zₓ comprising the first injection point for the first phase (2), x being greater than or equal to 1; and
at least one backwash zone included between a zone Zₓ₊₁ and a zone Zₙ comprising the third injection point for the backwash liquid (4), n being greater than x;
in which the trays (Pᵢ) of one and the same zone exhibit one and the same height H of inter-tray space (10); and
in which:
when x is greater than 1, the height H of the inter-tray spaces (10) of the zones Zᵢ increases when the value i increases; and
when x is equal to 1, the height H of the inter-tray spaces (10) of the at least one backwash zone is less than the height H of the inter-tray spaces (10) of the zone Z₁.

2. Liquid-liquid extraction column (1) according to claim 1, in which n is between 3 and 30 and x is greater than 1.

3. Liquid-liquid extraction column (1) according to claim 1, in which, in the extraction zones Zᵢ where i varies from 1 to x, the ratio of the height H of an inter-tray space (10) of a zone Zᵢ to the height H of an inter-tray space (10) of a zone Zᵢ₊₁ is between 0.20 and 0.95.

4. Liquid-liquid extraction column (1) according to claim 1, in which, in the extraction zones Zᵢ where i varies from 1 to x, the ratio of the height H of an inter-tray space (10) of a zone Zᵢ to the height H of an inter-tray space (10) of a zone Zᵢ₊₁ is between 0.40 and 0.90.

5. Liquid-liquid extraction column (1) according to claim 1, in which, when x is equal to 1, the ratio of the height H of an inter-tray space (10) of the at least one backwash zone to the height H of the inter-tray space (10) of the zone Z₁ is between 0.20 and 0.95.

6. Liquid-liquid extraction column (1) according to claim 1, in which the at least one backwash zone is a plurality of zones, from a zone Zₓ₊₁ to the zone Zₙ, and in which the height H of the inter-tray spaces (10) increases, is constant, or decreases from the zone Zₓ₊₁ to the zone Zₙ.

7. Liquid-liquid extraction column (1) according to claim 1, in which the at least one backwash zone is a plurality of zones subdivided into:
a plurality of zones Zⱼ included between the zone Zₓ₊₁ and a zone Z_{y}, y being greater than x+1; and
a plurality of zones Zₖ included between the zone Z_{y+1} and the zone Zₙ, and in which:
in the zones Zⱼ where j varies from x+1 to y, the height H of the inter-tray spaces (10) increases, is constant, or decreases when the value j increases; and/or
in the zones Zₖ where k varies from y+1 to n, the height H of the inter-tray spaces (10) increases, is constant, or decreases when the value k increases.

8. Liquid-liquid extraction column (1) according to claim 7, in which, in the zones Zⱼ where j varies from x+1 to y, the ratio of the height H of the inter-tray spaces (10) of a zone Zⱼ to the height H of the inter-tray spaces (10) of a zone Zⱼ₊₁ is between 0.20 and 0.95.

9. Liquid-liquid extraction column (1) according to claim 7, in which, in the zones Zⱼ where j varies from x+1 to y, the ratio of the height H of the inter-tray spaces (10) of a zone Zⱼ to the height H of the inter-tray spaces (10) of a zone Zⱼ₊₁ is between 1.10 and 2.0.

10. Liquid-liquid extraction column (1) according to claim 7, in which, in the zones Zₖ where k varies from y+1 to n, the ratio of the height H of the inter-tray spaces (10) of a zone Zₖ to the height H of the inter-tray spaces (10) of a zone Zₖ₊₁ is between 0.20 and 0.95.

11. Liquid-liquid extraction column (1) according to claim 7, in which, in the zones Zₖ where k varies from y+1 to n, the ratio of the height H of the inter-tray spaces (10) of a zone Zₖ to the height H of the inter-tray spaces (10) of a zone Zₖ₊₁ is between 1.10 and 2.0.

12. Liquid-liquid extraction column (1) according to claim 1, in which the number of zones Zᵢ is between 2 and 10 and/or the number of backwash zones is between 1 and 10.

13. Liquid-liquid extraction column (1) according to any one of Claims

7. claim 7, in which the number of zones Zⱼ is between 2 and 10 and/or the number of zones Zₖ is between 2 and 10.

14. Liquid-liquid extraction column (1) according to claim 1, in which the height H of the inter-tray spaces (10) of the backwash zone Zₓ₊₁ is less than, equal to or greater than the height H of the inter-tray spaces (10) of the extraction zone Zₓ.

15. Liquid-liquid extraction column (1) according to Claim 1, in which the height H of each inter-tray space (10) is between 0.2 m and 1.2 m.
